(19) United States
(12) Patent Application Publication
(10) Pub. No.: US 2005/0035088 A1
(43) Pub. Date: Feb. 17, 2005

(54) Method and apparatus for surface discharge processing, and an electrode for surface discharge processing

(76) Inventors: Kazunobu Fujikawa, Tokyo (JP); Akihiro Goto, Tokyo (JP)

Correspondence Address: SUGHRUE, MION, ZINN,;MACPEAK & SEAS, 2100 Pennsylvania Avenue NW, Washington, DC, 20037, US

(21) Appl. No.: 09/763,194

(22) Filed: Feb. 20, 2001

Related U.S. Application Data
(63) Continuation of application No. PCT/JP99/02379, filed on May 7, 1999.

(51) Int. Cl. C23C 26/00; B23H 7/00

(52) U.S. Cl. 219/69.12

(57) ABSTRACT

A surface discharge processing apparatus generates an electric discharge between an electrode and a workpiece (1) thereby forming a surface reforming layer on the surface of the workpiece. The apparatus comprises a wire electrode (2) for surface discharge processing used as the surface discharge processing electrode, and a wire electrode feeder composed of a feed reel (3) for feeding this wire electrode (2) for surface discharge processing to the workpiece (1), and a takeup reel (4) in additional to the conventional components. The wire electrode (2) is composed of a core wire (2a) made of ductile material, and a surface discharge processing material (2b) made of a surface reforming material adhered to this core wire or a raw material for the surface reforming material.

### TECHNICAL FIELD

The present invention in general relates to an improvement in the surface discharge processing method and apparatus, and a surface discharge processing electrode. More specifically, this invention relates to a technology for generating an electric discharge between an electrode and a workpiece, and forming a surface reforming layer on the surface of the workpiece by the discharge energy.

### BACKGROUND ART

As a prior art for forming a surface reforming layer on a workpiece by discharge in liquid and providing with corrosion resistance and wear resistance, for example, a surface discharge processing method is disclosed in Japanese Patent Application Laid-open No. 5-148615. This is a two-step surface discharge processing method of metal material. A primary processing (deposit processing) is performed by using a compacted powder electrode formed by compressing WC powder and Co powder. A secondary processing (re-fusing process) is performed by replacing the electrode with an electrode relatively small in electrode consumption such as copper electrode. In this prior art, a surface reforming layer of high hardness and high adhesion can be formed on a steel material.

Japanese Patent Application Laid-open No. 9-192937 discloses a surface discharge processing method of forming a rigid surface reforming layer without re-fusing process on the surface of iron, steel, or cemented carbide. This method makes use of a compacted powder electrode formed by compressing TiH₂ powder.

When such surface discharge processing technology is applied, for example, to the mold, the mold life can be extended notably owing to improvement in corrosion resistance and wear resistance.

When such a surface discharge processing is performed on the workpiece by using a molded electrode, as shown in FIG. 8(a) for example, when a first workpiece 21 is processed by a surface discharge processing electrode 22, a worn portion 22a is formed on the surface discharge processing electrode 22 and a surface reforming layer 23 is formed on the first workpiece 21. When a second workpiece 24 different in size from the first workpiece 21 is processed by the same surface discharge processing electrode 22 as used in surface discharge processing of the first workpiece 21, as shown in FIG. 8(b), worn portions 22b, 22c are formed on the surface discharge processing electrode 22, and a surface reforming layer 25 is formed on the second workpiece 24. The thickness of the surface reforming layer 25 is uneven as shown in FIG. 8(b), and uniform surface reforming layer cannot be formed.

In addition, multiple electrodes suited to the processing shapes must be prepared.

To solve these problems, it may be considered to use the surface reforming material or a raw material for the surface reforming material as the wire electrode itself, and process the discharge surface of the workpiece by using this wire electrode. However, for example, when Ti or W is used as wire electrode, it is not practical because the surface discharge processing speed is too slow. Furthermore, if the wire electrode is formed by using compacted powder, the tensile strength of the wire electrode is not guaranteed, and it is completely impracticable.

### DISCLOSURE OF THE INVENTION

The invention is intended to solve the conventional problems, and it is hence an object thereof to attain surface discharge processing method and apparatus and surface discharge processing electrode, suited to partial surface reforming of mold or the like, capable of forming a uniform surface reforming layer on the workpiece, not required to prepare multiple electrodes according to the processing shapes, and capable of keeping a practical surface discharge processing speed.

In a surface discharge processing method according to a first aspect of the invention, the surface discharge processing electrode is a wire electrode composed of a core wire made of ductile material, and a surface discharge processing material made of a surface reforming material adhered to this core wire or a raw material for the surface reforming material.

A surface discharge processing method according to a second aspect of the invention relates to the surface discharge processing method of the first aspect of the invention, in which a recess is formed in the core wire, and the surface discharge processing material is adhered to this recess.

A surface discharge processing method according to a third aspect of the invention relates to the surface discharge processing method of the second aspect of the invention, in which the recess formed in the core wire is spiral in shape.

A surface discharge processing method according to a fourth aspect of the invention relates to the surface discharge processing method of the first aspect of the invention, in which the processing program for performing the surface discharge processing is the processing program for wire discharge processing employed in a preparatory step of surface discharge processing.

In a surface discharge processing method according to a fifth aspect of the invention, a first wire electrode for removal processing by discharge, and a second wire electrode for surface discharge processing composed of a core wire made of ductile material, and a surface discharge processing material made of a surface reforming material adhered to this core wire or a raw material for the surface reforming material are changed over, and the processing is done by combination of removal processing of the workpiece, and surface discharge processing for reforming the surface of the processed side formed by this removal process.

A surface discharge processing apparatus according to a sixth aspect of the invention comprises a wire electrode used as the surface discharge processing electrode, and a wire electrode feeder for feeding the wire electrode to the workpiece. The wire electrode is composed of a core wire made of ductile material and a surface discharge processing material. The discharge processing material is made of a surface reforming material adhered to the core wire or a raw material for the surface reforming material.

A surface discharge processing apparatus according to a seventh aspect of the invention relates to the surface discharge processing apparatus of the sixth aspect of the invention, in which a recess is formed in the core wire, and the surface discharge processing material is adhered to this recess.

A surface discharge processing apparatus according to an eighth aspect of the invention relates to the surface discharge processing apparatus of the seventh aspect of the invention, in which the recess formed in the core wire is spiral in shape.

A surface discharge processing apparatus according to a ninth aspect of the invention relates to the surface discharge processing apparatus of the sixth aspect of the invention, in which the processing program for performing the surface discharge processing is the processing program for wire discharge processing employed in a preparatory step of surface discharge processing.

A surface discharge processing apparatus according to a tenth aspect of the invention comprises a first wire electrode for removal processing by discharge, a second wire electrode for surface discharge processing composed of a core wire made of ductile material, and a surface discharge processing material made of a surface reforming material adhered to this core wire or a raw material for the surface reforming material, a wire electrode feeder for feeding the first wire electrode and second wire electrode to the workpiece, and a wire electrode changeover unit which changes over the first wire electrode and second wire electrode.

In a surface discharge processing electrode according to an eleventh aspect of the invention, the surface discharge processing electrode is composed of a core wire made of ductile material, and a surface discharge processing material made of a surface reforming material adhered to this core wire or a raw material for the surface reforming material.

A surface discharge processing electrode according to a twelfth aspect of the invention relates to the surface discharge processing electrode of the eleventh aspect of the invention, in which a recess is formed in the core wire, and the surface discharge processing material is adhered to this recess.

A surface discharge processing electrode according to a thirteenth aspect of the invention relates to the surface discharge processing electrode of the twelfth aspect of the invention, in which the recess formed in the core wire is spiral in shape.

Having such structure as mentioned above, the invention brings about the following effects.

In the first aspect of the invention, the tensile strength of the wire electrode for surface discharge processing necessary for the processing work can be obtained by the strength of the core wire, and the surface reforming layer of a specific characteristic can be formed on the workpiece by the surface discharge processing material adhered to the core wire at a practical surface discharge processing speed. Besides, it is not necessary to prepare multiple electrodes according to processing shapes.

In the second aspect of the invention, in addition to the effects as in the first aspect of the invention, the fixing stability of surface discharge processing material on the core can be enhanced in the wire feeding process.

In the third aspect of the invention, in addition to the effects as in the second aspect of the invention, the surface reforming layer can be formed uniformly and stably on the workpiece.

In the fourth aspect of the invention, in addition to the effects as in the first aspect of the invention, the electrode path program for surface discharge processing can be created easily, and the preparation time for processing can be shortened.

In the fifth aspect of the invention, the tensile strength of the wire electrode for surface discharge processing necessary for the processing work can be obtained by the strength of the core wire, and the surface reforming layer of a specific characteristic can be formed on the workpiece by the surface discharge processing material adhered to the core wire at a practical surface discharge processing speed. Besides, it is not necessary to prepare multiple electrodes according to processing shapes. In addition, since the removal process of the workpiece and the surface discharge processing for reforming the surface of the processed side formed by this removal process can be done in the same preparatory step, the preparation time for workpiece shape processing and surface discharge processing can be shortened substantially.

In the sixth aspect of the invention, the same effects as in the first aspect of the invention are obtained.

In the seventh aspect of the invention, the same effects as in the second aspect of the invention are obtained.

In the eighth aspect of the invention, the same effects as in the third aspect of the invention are obtained.

In the ninth aspect of the invention, the same effects as in the fourth aspect of the invention are obtained.

In the tenth aspect of the invention, the same effects as in the fifth aspect of the invention are obtained.

In the eleventh aspect of the invention, the same effects as in the first aspect of the invention are obtained, in surface discharge processing by using the surface discharge processing electrode of the invention.

In the twelfth aspect of the invention, the same effects as in the second aspect of the invention are obtained, in surface discharge processing by using the surface discharge processing electrode of the invention.

In the thirteenth aspect of the invention, the same effects as in the third aspect of the invention are obtained, in surface discharge processing by using the surface discharge processing electrode of the invention.

### BRIEF DESCRIPTION OF THE DRAWINGS

FIG. 1 is structural diagram showing a surface discharge processing apparatus in a first embodiment of the invention;

FIG. 2 is a sectional view showing the structure of a wire electrode for surface discharge processing in the first embodiment of the invention;

FIG. 3 is a side view showing the structure of the wire electrode for surface discharge processing in the first embodiment of the invention;

FIG. 4 is an explanatory diagram of a method of surface discharge processing in a cutting edge side portion of the workpiece in the first embodiment of the invention;

FIG. 5 is structural diagram showing a surface discharge processing apparatus in a second embodiment of the invention;

FIG. 6 is an explanatory diagram of an example of structure of a wire electrode changeover unit in the second embodiment of the invention;

FIG. 7 is an explanatory diagram of electrode moving path in the second embodiment of the invention; and

FIG. 8 is an explanatory diagram showing a conventional discharge electrode processing method.

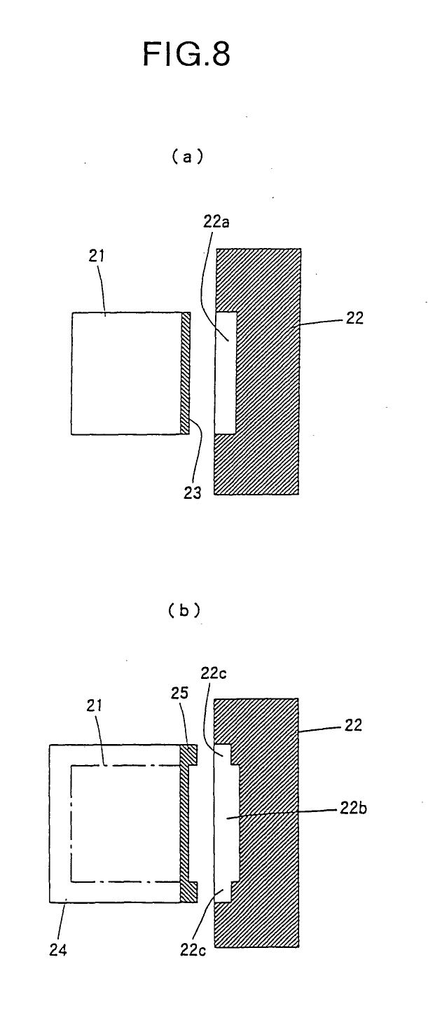

### BEST MODE FOR CARRYING OUT THE INVENTION

First Embodiment:

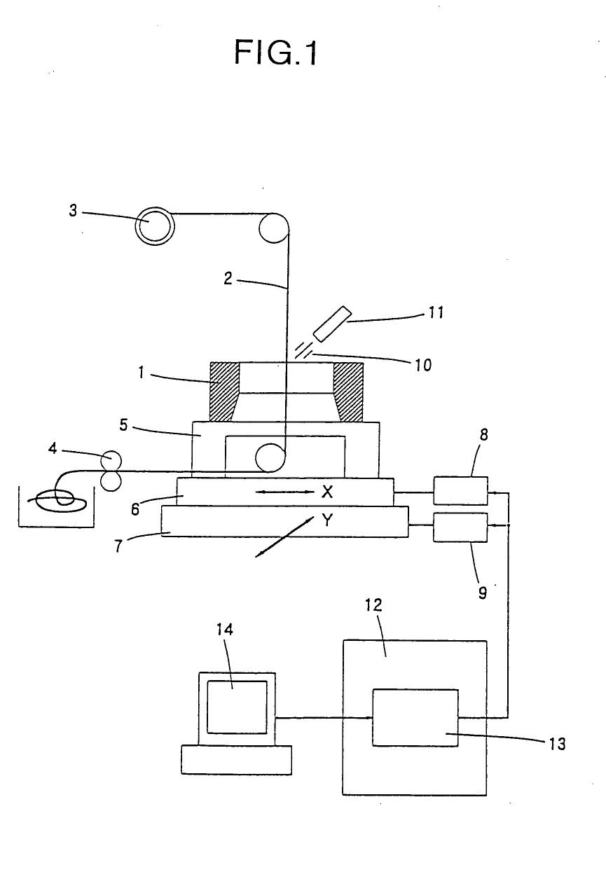

FIG. 1 is structural diagram showing a surface discharge processing apparatus in a first embodiment of the invention. Legend 1 denotes a workpiece, legend 2 denotes a wire electrode for surface discharge processing, legend 3 denotes a feed reel for feeding the wire electrode 2, legend 4 denotes a takeup reel for collecting the wire electrode, legend 5 denotes a platen for fixing the workpiece 1, legend 6 denotes an X-table for driving the workpiece 1 in a horizontal direction (X-axis direction), legend 7 denotes a Y-table for driving the workpiece 1 in a horizontal direction (Y-axis direction), legend 8 denotes an X-axis servo amplifier for a not shown X-axis drive motor which drives the X-table 6, legend 9 denotes a Y-axis servo amplifier for a not shown Y-axis drive motor which drives Y-table 7, legend 10 denotes a coolant, legend 11 denotes a coolant nozzle through which the coolant 10 is injected, legend 12 denotes an NC unit, legend 13 denotes a locus move control unit provided in the NC unit 12 for controlling relative move of the wire electrode 2 for surface discharge processing and the workpiece 1, and legend 14 denotes a CAM system for generating electrode move locus for supplying an electrode path program (NC program) for processing by the wire electrode 2 for surface discharge processing into the locus move control unit 13. The wire electrode 2 for surface discharge processing is fed onto the workpiece 1 by a wire electrode feeder composed of the feed reel 3, takeup reel 4 and others, and a surface reforming layer is formed on the workpiece by the discharge between the wire electrode 2 for surface discharge processing and the workpiece 1.

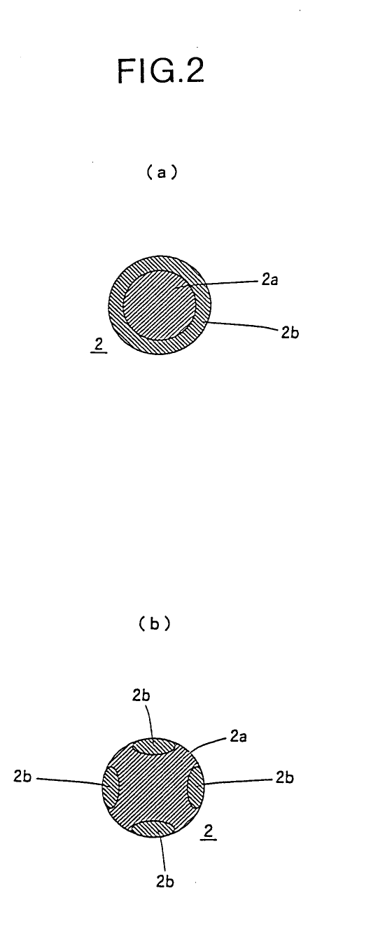

The wire electrode 2 for surface discharge processing is composed of a core wire 2a and a surface discharge processing material 2b as shown in a sectional view in FIG. 2, and the core wire 2a is made of brass or other ductile material. The surface discharge processing material 2b is made of a surface reforming material or a raw material for surface reforming material. This surface discharge processing material 2b is adhered to the core wire 2a by coating, dipping, plating, or pressing. Alternatively, the surface discharge processing material 2b may be mixed in a conductive paint, and applied to the core wire 2a. In this case, as shown in FIG. 2(b), by forming a recess in the core wire 2a, and adhering the surface discharge processing material 2b to this recess, the fixing stability of the surface discharge processing material 2b on the core wire 2a may be enhanced in the wire feed process. The shape of the recess to be formed in the core 2a is not limited to the shape and number of recesses shown in FIG. 2(b), but may be formed in any shape or number so as to be capable of enhancing the fixing stability of the surface discharge processing material 2b on the core wire 2a.

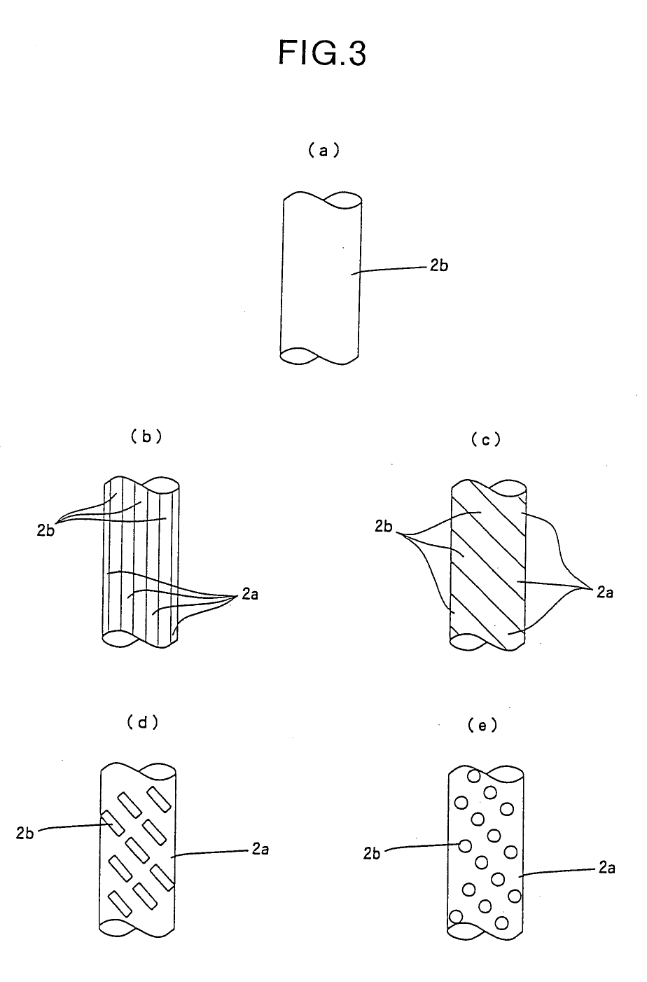

FIG. 3 is a side view of the wire electrode 2 for surface discharge processing, in which FIG. 3(a) corresponds to the sectional view shown in FIG. 2(a), and FIG. 3(b) to (e) correspond to the sectional view shown in FIG. 2(b). A spiral recess may be formed in the core wire 2a as shown in FIG. 3(c). In this case, the fixing stability of the surface discharge processing material 2b on the core wire 2a is enhanced in the wire feed process as mentioned above, and moreover the surface reforming layer can be formed more uniformly and stably on the workpiece 1.

By using the wire electrode 2 for surface discharge processing having such composition, the tensile strength of the wire electrode 2 for surface discharge processing necessary for the processing work can be obtained by the strength of the core wire 2a. Furthermore, the surface reforming layer of a specific characteristic can be formed on the workpiece 1 by the surface discharge processing material 2b adhered to the core wire 2a at a practical surface discharge processing speed.

The operation in surface discharge processing of the workpiece 1 is explained below. It is assumed that the workpiece 1 is a press mold. Furthermore, it is assumed that, before the step of surface discharge processing, the workpiece 1 is processed by grinding or wire discharge processing, and the shape as the cutting edge of the press mold has been already formed. In FIG. 1, the workpiece 1 is put and fixed on the platen 5. The wire electrode 2 for surface discharge processing is set in place, and surface discharge processing is started. Resultantly, a hard surface reforming layer is formed on the cutting edge side surface of the workpiece 1. For this purpose, the wire electrode 2 for surface discharge processing must be controlled so as to move along the cutting edge profile of the workpiece 1. The locus move control unit 13 provided in the NC unit 12 drives and controls the X-table 6 and Y-table 7 according to the electrode path information preliminarily created by the CAM device 14 for generating electrode move locus, moves the wire electrode 2 for surface discharge processing and workpiece 1 relatively in the horizontal direction, and controls the locus move of the wire electrode 2 for surface discharge processing so as to copy the cutting edge profile of the workpiece 1.

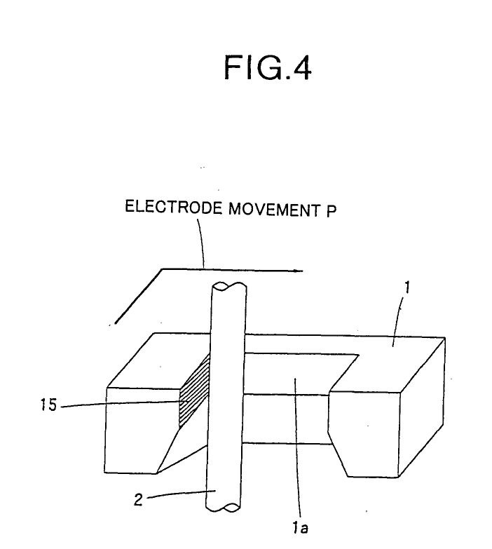

FIG. 4 is an explanatory diagram of method of surface discharge processing on the cutting edge side portion 1a of the workpiece 1. As the surface discharge processing progresses, the wire electrode 2 for surface discharge processing is consumed. However, since the wire electrode 2 for surface discharge processing is fed by the feed reel 3 shown in FIG. 1, it is possible to always perform the surface discharge processing with a fresh (non-consumed) wire electrode 2 for surface discharge processing. Therefore, the electrode movement (P in FIG. 4) of the wire electrode 2 for surface discharge processing may be same as the electrode move path in wire discharge processing. Thus, by performing surface discharge processing by moving the wire electrode 2 for surface discharge processing so as to copy the cutting edge profile of the workpiece 1, a hard surface reforming layer 15 can be formed in the cutting edge side portion 1a of the workpiece 1.

In this method, a hard surface reforming layer is formed by surface discharge processing on the cutting edge side portion of a blanking mold, and a press blanking test was conducted, and, as a result, as compared with the case not performing surface discharge processing, the shear droop of the pressed work after 400000 shots was less than half, and the mold life was extended.

Not only in such blanking mold, but also in other shapes that can be processed by wire discharge processing (two-dimensional shape, envelope shape), for example, extrusion mold, punch, drill and other cutting edges, the surface discharge processing of the invention can be applied, and same effects are obtained.

Further, as the electrode path program of surface discharge processing, by using the processing program of wire discharge processing employed at a preparatory step of the workpiece 1, the electrode path program for surface discharge processing can be created easily, and the time required for preparation of the process can be shortened.

Second Embodiment:

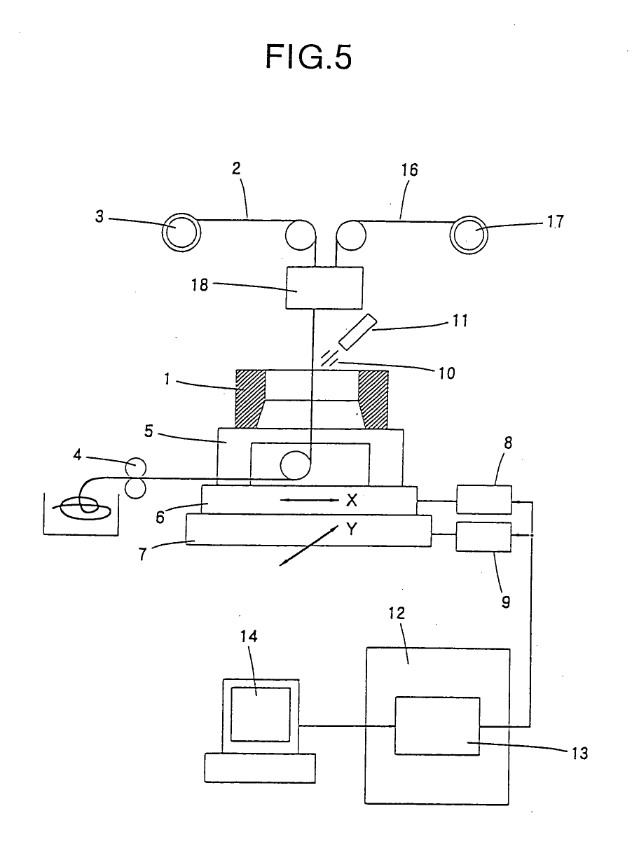

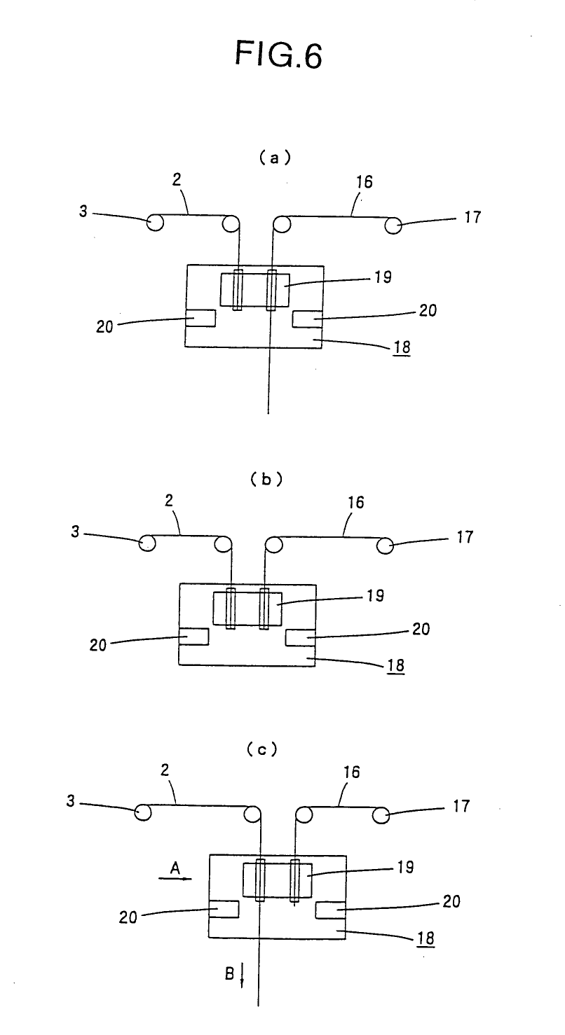

FIG. 5 is structural diagram showing a surface discharge processing apparatus in a second embodiment of the invention. Same or corresponding parts as in the first embodiment shown in FIG. 1 are provided with the same legends. In FIG. 5, legend 16 denotes a wire electrode for wire discharge processing used in ordinary removal process, legend 17 denotes a feed reel, and legend 18 denotes a wire electrode changeover unit for changing over between the wire electrode 2 for surface discharge processing and the wire electrode 16 for wire discharge processing, depending on the type of processing work. FIG. 6 is an explanatory diagram showing an example of structure of the wire electrode changeover unit 18. Legend 19 denotes a wire fixing unit, and legend 20 denotes a wire cutting device. After processing by the wire electrode 16 for wire discharge processing as shown in FIG. 6(a), the wire electrode 16 for wire discharge processing is cut off by the wire cutting device 20 as shown in FIG. 6(b). Next, as shown in FIG. 6(c), the wire electrode changeover unit 18 is moved in a direction A shown by an arrow in the diagram by means of a not shown drive device, and the wire electrode 2 for surface discharge processing is fed and loaded in direction B in the diagram. The operation is same when changing over from the wire electrode 2 for surface discharge processing to the wire electrode 16 for wire discharge processing.

The processing of the workpiece 1 will be now explained. It is assumed that the workpiece 1 is a press mold. Referring to FIG. 5, the workpiece 1 is put and fixed on the platen 5. The wire electrode 16 for wire discharge processing is set in place, and wired is charge processing is started. Wire discharge processing consists of steps of ordinary rough processing, finish processing, and cutting edge finish processing, and a cutting edge shape to be used as a press mold is formed in the workpiece 1. Consequently, the wire electrode changeover unit 18 changes over the electrode to the wire electrode 2 for surface discharge processing. Thereafter, the same surface discharge processing as in the first embodiment is performed on the cutting edge side surface of the workpiece 1 processed by the wire discharge processing and a hard surface reforming layer is formed on the cutting edge side surface of the workpiece 1.

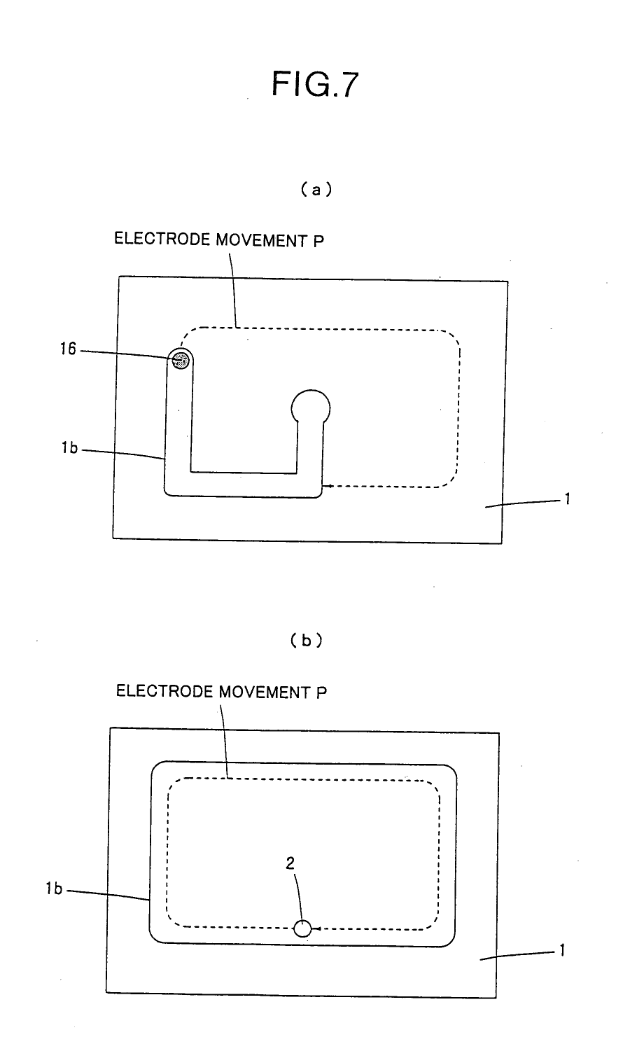

FIG. 7 explains the electrode movement in the second embodiment of the invention. FIG. 7(a) explains wire discharge processing, and FIG. 7(b) explains surface discharge processing. In the wire discharge processing in FIG. 7(a), the locus move control unit 13 provided in the NC unit 12 drives and controls the X-table 6 and Y-table 7 according to the electrode path information preliminarily created by the CAM device 14 for generating electrode move locus, moves the wire electrode 16 for wire discharge processing and workpiece 1 relatively in the horizontal direction, and processes the workpiece 1 into a cutting edge shape. In the surface discharge processing in FIG. 7(b) it is required to provide a control such that the wire electrode 2 for surface discharge processing shall move along the cutting edge shape 1b of the workpiece 1. In this case, in the same manner as in the ordinary finish processing of wire discharge processing, the locus move control unit 13 provided in the NC unit 12 drives and controls the X-table 6 and Y-table 7 according to the electrode path information preliminarily created by the CAM device 14 for generating electrode move locus, moves the wire electrode 2 for surface discharge processing and workpiece 1 relatively in the horizontal direction, and controls the locus move of the wire electrode 2 for surface discharge processing so as to copy the cutting edge profile of the workpiece 1.

Thus, by processing the cutting edge portion of the workpiece 1 by wire discharge processing, and performing surface discharge processing so as to copy the cutting edge shape after processing of the cutting edge side portion 1b, a hard surface reforming layer is formed in the cutting edge side portion 1b, and therefore the mold life can be extended substantially same as in the first embodiment. Further, since the removal process of the workpiece 1 and the surface discharge processing can be done in the same preparatory step, the preparation time for processing can be shortened substantially.

The change over of the wire electrode 16 for wire discharge processing and the wire electrode 2 for surface discharge processing may be performed automatically by the wire electrode changeover unit 18. On the other hand, the change over of the wire discharge processing and surface discharge processing may be performed manually by an operator, or by a running system for wire electrode 16 for wire discharge processing and a running system for wire electrode 2 for surface discharge processing provided independently.

### INDUSTRIAL APPLICABILITY

The surface discharge processing method and apparatus and surface discharge processing electrode of the invention are suited to be used in surface discharge processing for forming a surface reforming layer on the surface of a workpiece.

1. (Canceled)

2. (Canceled)

3. (Canceled)

4. (Canceled)

5. (Canceled)

6. A surface discharge processing apparatus comprising:
a wire electrode which generates an electric discharge between said wire electrode and a workpiece thereby forming a surface reforming layer on a surface of said workpiece; and
a wire electrode feeder which feeds said wire electrode to said workpiece during surface discharge processing,
wherein said wire electrode is composed of a core wire made of ductile material, and a surface discharge processing material made of a surface reforming material or a raw material therefore adhered to said core wire, wherein a recess is formed in said core wire, and said surface discharge processing material is adhered to the recess.

7. (Canceled)

8. The surface discharge processing apparatus according to claim 8, wherein the recess formed in said core wire is spiral in shape.

9. The surface discharge processing apparatus according to claim 6, wherein the surface discharge processing apparatus operates under the control of a processing program which controls wire discharge processing employed in a preparatory step of surface discharge processing.

10. A surface discharge processing apparatus which generates an electric discharge between a surface discharge processing electrode and a workpiece thereby forming a surface reforming layer on a surface of said workpiece, said surface discharge processing apparatus comprising:
a first wire electrode for removal processing by electric discharge;
a second wire electrode for surface discharge processing composed of a core wire made of ductile material, and a surface discharge processing material made of a surface reforming material or a raw material therefore adhered to said core wire;
a wire electrode feeder which feeds said first wire electrode and second wire electrode to said workpiece during the processing; and
a wire electrode changeover unit which can select said first wire electrode when removal processing is to be performed or select said second wire electrode when surface discharge processing is to be performed.

11. (Canceled)

12. (Canceled)

13. (Canceled)
